(19) United States
(12) Patent Application Publication
(10) Pub. No.: US 2011/0280750 A1
(43) Pub. Date: Nov. 17, 2011

(54) Reciprocating Refrigeration Compressor

(75) Inventor: Paul J. Flanigan, Cicero, NY (US)

(73) Assignee: CARRIER CORPORATION, Farmington, CT (US)

(21) Appl. No.: 13/146,453

(22) PCT Filed: Nov. 24, 2009
(86) PCT No.: PCT/US09/65685

§ 371 Date: Jul. 27, 2011

Related U.S. Application Data
(60) Provisional application No. 61/150,713, filed on Feb. 6, 2009.

(51) Int. Cl. F04B 35/04; F25D 11/00; B23P 15/00; F25B 1/00

(52) U.S. Cl. 417/410.1; 62/498; 62/457.9; 62/441; 29/888.02

(57) ABSTRACT

A compressor (20) has a case (22) and a crankshaft (38). The case has a number of cylinders (30 32). For each of the cylinders, the compressor includes a piston (34) mounted for reciprocal movement at least partially within the cylinder. A connecting rod (36) couples each piston to the crankshaft. A pin (44) couples each connecting rod to the associated piston. Each pin has first (52) and second (53) end portions mounted to first (56) and second (57) receiving portions of the associated piston and a central portion (48) engaging the associated connecting rod. Each of the pistons is formed of a first cast iron. At each of the cylinders, the case is formed of second cast iron. One of the first cast iron and the second cast iron is a Meehanite type cast iron and the other of the first cast iron and the second cast iron is a gray cast iron.

### CROSS-REFERENCE TO RELATED APPLICATION

Benefit is claimed of U.S. Patent Application Ser. No. 61/150,713, filed Feb. 6, 2009, and entitled “Reciprocating Refrigeration Compressor”, the disclosure of which is incorporated by reference herein in its entirety as if set forth at length.

### BACKGROUND

The present disclosure relates to refrigeration compressors. More particularly, it relates to reciprocating piston compressors for use with carbon dioxide-based refrigerants.

A variety of refrigerant compressor configurations are in common use. Among these configurations are: screw compressors; scroll compressors; and reciprocating piston compressors. One particular subfield of refrigeration systems is transport refrigeration systems (e.g., truck, trailer, and cargo container refrigeration systems). An exemplary state of the art transport refrigeration system uses an internal combustion engine to directly or indirectly drive a reciprocating piston compressor. One current transport refrigeration system uses a diesel-electric hybrid system to electrically power a reciprocating piston compressor which uses R-404A HFC refrigerant.

More recently, it has been proposed to use carbon dioxide-based refrigerants (e.g., R-744) for transport applications due to concerns regarding the environmental impact of HFCs. R-744 has also been proposed for use with electric-powered reciprocating piston compressors used as central compressors for distributed retail display cabinets.

### SUMMARY

One aspect of the disclosure involves a compressor having a case and a crankshaft. The case has a number of cylinders. For each of the cylinders, the compressor includes a piston mounted for reciprocal movement at least partially within the cylinder. A connecting rod couples each piston to the crankshaft. A pin couples each connecting rod to the associated piston. Each pin has first and second end portions mounted to first and second receiving portions of the associated piston and a central portion engaging the associated connecting rod. Each of the pistons is formed of a first cast iron. At each of the cylinders, the case is formed of second cast iron. One of the first cast iron and the second cast iron is a Meehanite-type cast iron and the other of the first cast iron and the second cast iron is a gray cast iron.

In various implementations, an electric motor within the case may be coupled to the crankshaft. The second cast iron may comprise a sleeve in a third cast iron. The third case iron may be a ductile iron. For each said pin, the respective end portions may be press fit in the associated piston receiving portions. The Meehanite-type cast iron may have an ultimate tensile strength greater than an ultimate tensile strength of the gray cast iron. The Meehanite-type cast iron may have an ultimate tensile strength of 250-375 N/mm2 and the gray cast iron may have an ultimate tensile strength of 200-250 N/mm2. The gray cast iron may have an ultimate tensile strength of 250-375 N/mm2 and the gray cast iron may have an ultimate tensile strength of 200-250 N/mm2. The Meehanite-type cast iron may have a lower machinability than a machinability of the gray cast iron. The Meehanite-type cast iron may have lower coefficient of friction than a coefficient of the gray cast iron. The Meehanite-type cast iron may have greater self-lubrication than the gray cast iron. The Meehanite-type cast iron may have a greater wear resistance than the gray cast iron. Each piston may be essentially uncoated (e.g., lacking a solid wear-resistant or lubricating coating).

Other aspects of the disclosure involve a refrigeration system including such a compressor. The refrigeration system may include a recirculating flowpath through the compressor. A first heat exchanger may be positioned along the flowpath downstream of the compressor. An expansion device may be positioned along the flowpath downstream of the first heat exchanger. A second heat exchanger may be positioned along the flowpath downstream of the expansion device. The refrigerant charge may comprise at least 50% carbon dioxide by weight. The system may be a refrigerated transport system. The refrigerated transport system may further comprise a container. The second heat exchanger may be positioned to cool an interior of the container. The system may be a fixed refrigeration system. The fixed refrigeration system may further comprise multiple refrigerated spaces. There may be a plurality of said second heat exchangers, each being positioned to cool an associated such refrigerated space.

Other aspects of the disclosure involve methods of manufacture. The compressor may be manufactured by mounting the connecting rods to the pistons via the pins. The pistons may be inserted into the cylinders in an essentially uncoated state. The connecting rods may be mated to the crankshaft. The case may be assembled over the crankshaft.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a side view of a compressor.

FIG. 2 is a vertical longitudinal sectional view of the compressor of FIG. 1.

FIG. 3 is a partial vertical longitudinal sectional view of a cylinder of the compressor of FIG. 1.

FIG. 4 is a schematic view of a refrigeration system.

FIG. 5 is a partially schematic view of a tractor trailer combination including the system of FIG. 4.

FIG. 6 is a schematic view of a fixed commercial refrigeration system.

Like reference numbers and designations in the various drawings indicate like elements.

### DETAILED DESCRIPTION

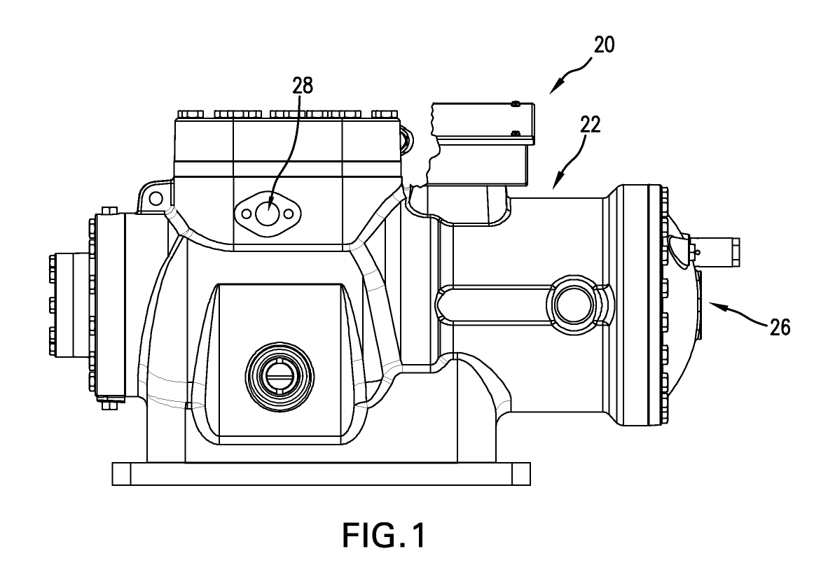

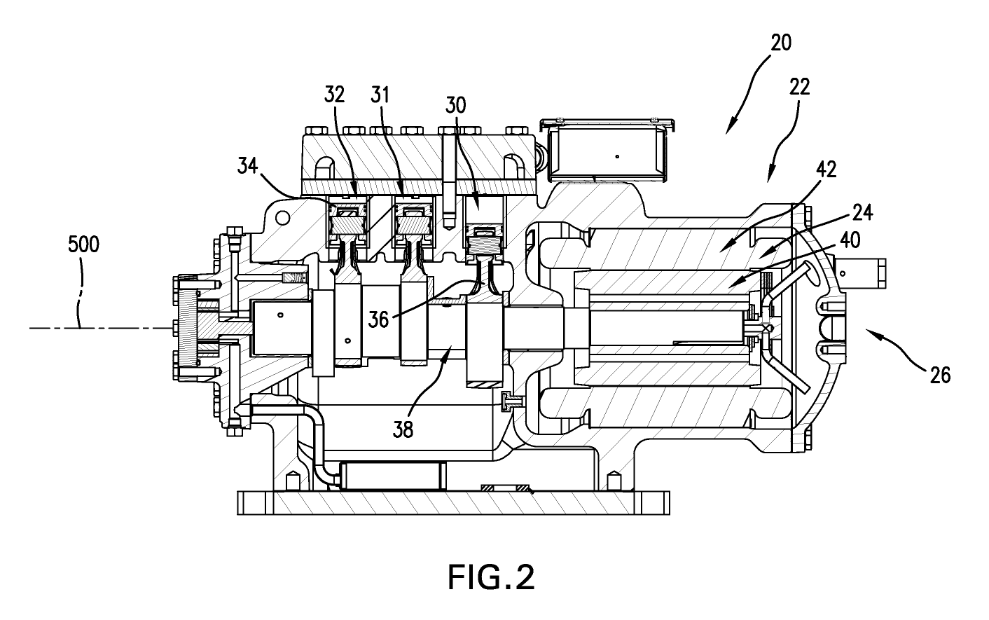

FIGS. 1 and 2 show an exemplary compressor 20 based upon the configuration shown in U.S. Patent Application 61/098,102, filed Sep. 19, 2008 and International Application PCT/US09/57153, filed Sep. 16, 2009. When implemented as a reengineering of the configuration of such a baseline compressor, the exemplary compressor may replace coated gray cast iron pistons with uncoated Meehanite-type cast iron pistons. Among potential advantages of such a reengineering are significantly manufacturing cost reductions without undue performance degradation. For example, whereas protective and/or antifriction coatings (e.g., a non-metallic, oil-absorptive coating comprising manganese phosphates such as sold by Henkel Technologies of Madison Heights, Mich. under the trademark PARCO LUBRITE of thickness in excess of 0.0001 inch) may be desired on gray cast iron pistons, such coatings may be eliminated with the present pistons. Specific exemplary piston material is a flake graphite cast iron having a pearlitic matrix. Specific examples are Meehanite (trademark of Meehanite Metal Corp., Mequon, Wis.) flake graphite GA350 (GA50) having a corresponding nominal ultimate tensile strength (UTS) of 350N/mm² (50 ksi) and GC275 (GC40) having nominal tensile strength of 275N/mm² (40 ksi). A broader exemplary tensile strength is 250-375N/mm².

The Meehanite-on-gray cast iron interaction may have reduced wear and friction relative to the self-wear and friction properties of gray cast iron. This may be due to the combined morphology and free graphite presence of the Meehanite cast iron. Thus, the Meehanite cast iron allows coating elimination.

The compressor 20 has a housing (case) assembly 22. The exemplary compressor includes an electric motor 24 (FIG. 2). The exemplary case 22 has a suction port (inlet) 26 and a discharge port (outlet) 28. The housing defines a plurality of cylinders 30, 31, and 32. Each cylinder accommodates an associated piston 34 mounted for reciprocal movement at least partially within the cylinder. Exemplary multi-cylinder configurations include: in-line; V (vee); and horizontally opposed. The exemplary in-line compressor includes three cylinders. Each of the cylinders includes a suction location and a discharge location. For example, the cylinders may be coupled in parallel so that the suction location is shared/common suction plenum fed by the suction port 26 and the discharge location is a shared/common discharge plenum feeding the discharge port 28. In other configurations, the cylinders may share suction locations/conditions but have different discharge locations/conditions. In other configurations, the cylinders may be in series. Exemplary refrigerant is carbon dioxide (CO₂)-based (e.g., at least 50% CO₂ by mass/weight).

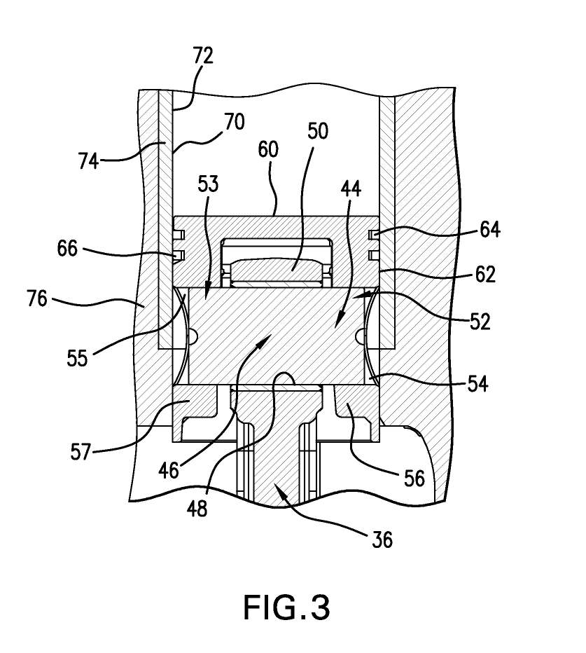

Each of the pistons 34 is coupled via an associated connecting rod 36 to a crankshaft 38. The exemplary crankshaft 38 is held within the case by bearings for rotation about an axis 500. The exemplary crankshaft is coaxial with a rotor 40 and stator 42 of the motor 24. Each piston 30-32 is coupled to its associated connecting rod 36 via an associated wrist pin 44. FIG. 3 shows the pin 44 as having a central portion 46 mounted for rotation in an aperture 48 in a distal end portion 50 of the connecting rod 36. The exemplary aperture is in a bushing 51 interference fit in a main piece of the connecting rod. The pin has first and second end portions 52 and 53 mounted in apertures 54 and 55 of associated receiving portions 56 and 57 of the piston (e.g., via interference fit such as press fit).

The exemplary piston has a distal end face 60 and a lateral/circumferential surface 62. One or more sealing rings 64 may be carried in corresponding grooves 66 in the surface 62.

In the exemplary cylinders, at least a portion of a cylinder wall/surface 70 is formed by the interior surface 72 of a sleeve 74. The exemplary sleeve 74 is formed of a gray cast iron and is interference fit (e.g., press fit) in a corresponding case member (e.g., a cylinder block 76). The exemplary cylinder block 76 comprises a ductile iron casting. An exemplary gray cast iron for the sleeve 74 (or for an alternative cylinder block lacking such a sleeve) is an ASTM Class 35 iron. Nominal UTS for Class 35 gray cast iron is 250 N/mm² (35 ksi). An exemplary UTS range is 200-255 N/mm². The exemplary gray cast iron has better machinability and lower cost than exemplary Meehanite. For example, exemplary American Iron and Steel Institute (AISI) machinability rating for gray cast iron is 110 whereas an exemplary machinability rating for Meehanite-type cast iron is 47. However, the exemplary gray cast iron has inferior self-lubrication and coefficient of friction and wear resistance relative to the Meehanite-type cast iron. Thus, Meehanite-on-gray cast iron friction will be lower than gray-on-gray. In an alternative embodiment, the piston and sleeve materials are reversed so that the piston comprises or consists essentially of the gray cast iron and the sleeve comprises or consists essentially of the Meehanite-type cast iron.

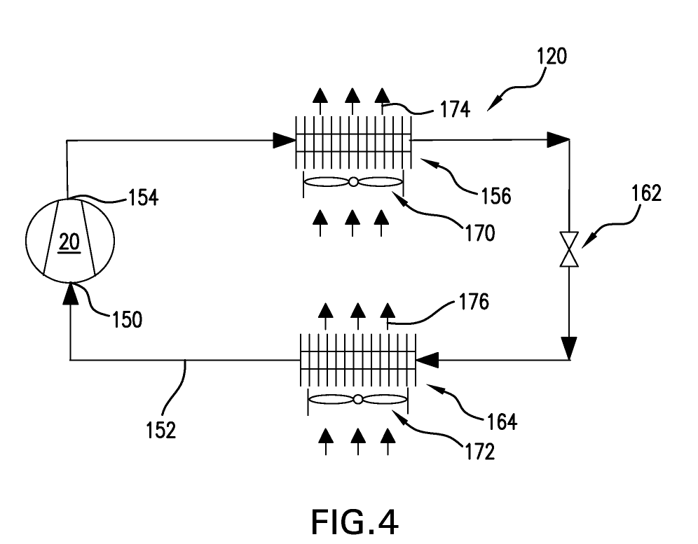

FIG. 4 shows an exemplary refrigeration system 120 including the compressor 20. The system 120 includes a system suction location/condition 150 at the suction port 26. A refrigerant primary flowpath 152 proceeds downstream from the suction location/condition 150 through the compressor cylinders in parallel to be discharged from a discharge location/condition 154 at the discharge port 28. The primary flowpath 152 proceeds downstream through the inlet of a first heat exchanger (gas cooler/condenser) 156 to exit the outlet of the gas cooler/condenser. The primary flowpath 152 then proceeds downstream through an expansion device 162. The primary flowpath 152 then proceeds downstream through a second heat exchanger (evaporator) 164 to return to the suction condition/location 150.

In a normal operating condition, a recirculating flow of refrigerant passes along the primary flowpath 52, being compressed in the cylinders. The compressed refrigerant is cooled in the gas cooler/condenser 156, expanded in the expansion device 162, and then heated in the evaporator 164. In an exemplary implementation, the gas cooler/condenser 156 and evaporator 164 are refrigerant-air heat exchangers with associated fan (170; 172)-forced airflows (174; 176). The evaporator 164 may be in the refrigerated space or its airflow may pass through the refrigerated space. Similarly, the gas cooler/condenser 156 or its airflow may be external to the refrigerated space.

Additional system components and further system variations are possible (e.g., multi-zone/evaporator configurations, economized configurations, and the like). Exemplary systems include refrigerated transport units and fixed commercial refrigeration systems.

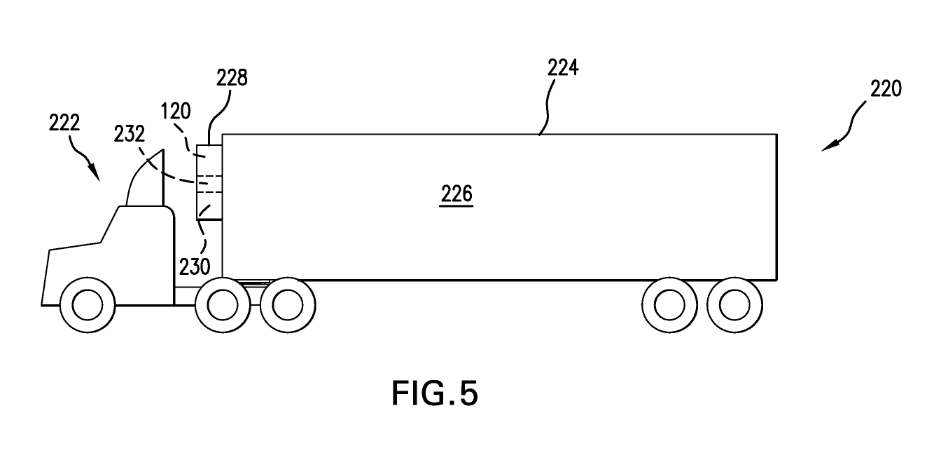

FIG. 5 shows a refrigerated transport unit (system) 220 in the form of a refrigerated trailer. The trailer may be pulled by a tractor 222. The exemplary trailer includes a container/box 224 defining an interior/compartment 226 (the refrigerated space). An equipment housing 228 mounted to a front of the box 224 may contain an electric generator system including an engine 230 (e.g., diesel) and an electric generator 232 mechanically coupled to the engine to be driven thereby. The refrigeration system 120 may be electrically coupled to the generator 232 to receive electric power. The evaporator and its associated fan may be positioned in or otherwise in thermal communication with the compartment 226.

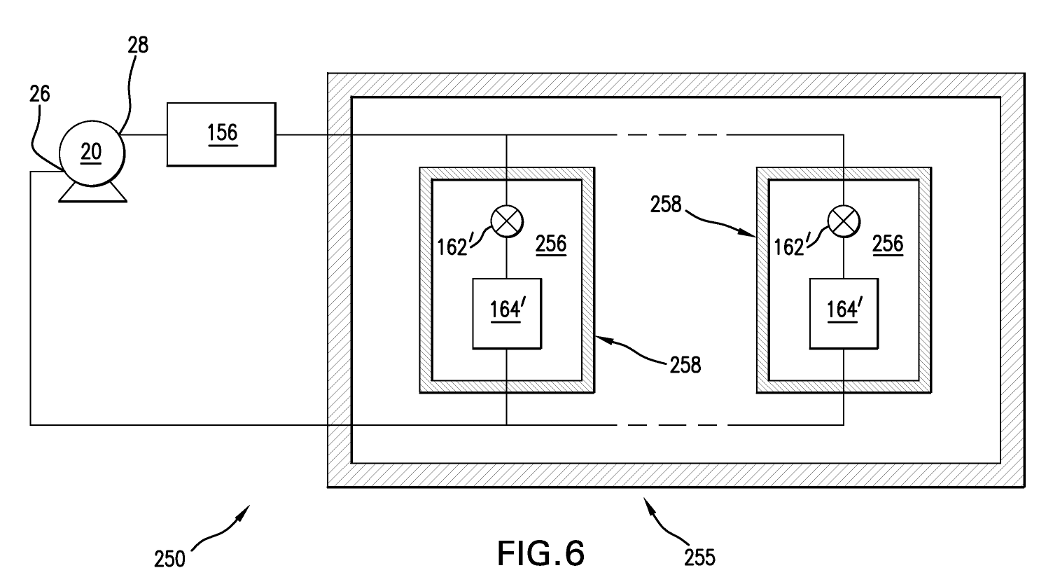

An exemplary fixed commercial refrigeration system 250 (FIG. 6) includes one or more central compressors 20 and heat rejection heat exchangers 156 (e.g., outside/on a building 255) commonly serving multiple refrigerated spaces 256 (e.g., of retail display cabinets 258 in the building). Each such refrigerated space may have its own heat absorption heat exchanger 164′ and expansion device 162′ (or there may be a common expansion device).

The compressor may be manufactured via otherwise conventional manufacturing techniques. The pistons, sleeves, and cylinder block may be cast and machined as may other components. Assembly may be performed in the absence of the aforementioned antifriction/coatings on the pistons and sleeves but with an assembly lubricant (e.g., an oil or grease). The assembly may involve mounting the connecting rods to the pistons via the pins. The pistons may be inserted into the cylinders in such an uncoated (but lubricated) state. The connecting rods may be mated to the crankshaft. The case may be assembled over the crankshaft (e.g., by mating a sump to the cylinder block). The remaining elements may be assembled.

Although an embodiment is described above in detail, such description is not intended for limiting the scope of the present disclosure. It will be understood that various modifications may be made without departing from the spirit and scope of the disclosure. For example, when implemented in the reengineering of an existing compressor configuration, details of the existing configuration may influence or dictate details of any particular implementation. Accordingly, other embodiments are within the scope of the following claims.

1. A compressor (20) comprising:
a case (22) having a plurality of cylinders (30-32);
a crankshaft (38); and
for each of said cylinders:
a piston (34) mounted for reciprocal movement at least partially within the cylinder;
a connecting rod (36) coupling the piston to the crankshaft; and
a pin (44) coupling the connecting rod to the piston, the pin having: first (52) and second (53) end portions mounted in first (56) and second (57) receiving portions of the piston; and a central portion (48) engaging the connecting rod,
wherein:
each of the pistons comprises a first cast iron;
at each of the cylinders, the case comprises a second cast iron; and
one of said first cast iron and said second cast iron is a Meehanite-type cast iron and the other of said first cast iron and said second cast iron is a gray cast iron.

2. The compressor of claim 1 further comprising:
an electric motor (24) within the case coupled to the crankshaft.

3. The compressor of claim 1 wherein:
the second cast iron comprises a sleeve (74) in a third cast iron (76), the third cast iron being a ductile iron.

4. The compressor of claim 1 wherein:
for each said pin, the respective end portions are press fit in the associated piston receiving portions.

5. The compressor of claim 1 wherein:
said Meehanite-type cast iron has an ultimate tensile strength greater than an ultimate tensile strength of the gray cast iron.

6. The compressor of claim 1 wherein:
the Meehanite-type cast iron has an ultimate tensile strength of 250-375 N/mm² and the gray cast iron has an ultimate tensile strength of 200-250 N/mm².

7. The compressor of claim 1 wherein:
said Meehanite-type cast iron has a lower machinability than a machinability of the gray cast iron.

8. The compressor of claim 1 wherein:
said Meehanite-type cast iron has a lower coefficient of friction than a coefficient of the gray cast iron.

9. The compressor of claim 1 wherein:
said Meehanite-type cast iron has greater self-lubrication than the gray cast iron.

10. The compressor of claim 1 wherein:
each said piston is essentially uncoated.

11. A refrigeration system (120; 250) comprising:
the compressor (20) of claim 1;
a refrigerant recirculating flowpath (152) through the compressor;
a first heat exchanger (156) along the flowpath downstream of the compressor;
an expansion device (162; 162′) along the flowpath downstream of the first heat exchanger; and
a second heat exchanger (164; 164′) along the flowpath downstream of the expansion device.

12. The refrigeration system of claim 11 wherein:
a refrigerant charge comprises at least 50% carbon dioxide by weight.

13. The system of claim 11 being a refrigerated transport system further comprising:
a container (224), the second heat exchanger being positioned to cool an interior (226) of the container.

14. The system of claim 11 being a fixed refrigeration system further comprising:
multiple refrigerated spaces (256); and
a plurality of said second heat exchangers (164′), each being positioned to cool an associated said refrigerated space.

15. A method for manufacturing the compressor of claim 1 comprising:
mounting the connecting rods to the pistons via the pins;
inserting the pistons into the cylinders in an essentially uncoated state;
mating the connecting rods to the crankshaft; and
assembling the case over the crankshaft.

16. The compressor of claim 1 wherein:
said first cast iron is said Meehanite-type cast iron; and
said second cast iron is said gray cast iron.

17. The compressor of claim 16 wherein:
each said piston is essentially uncoated.

18. The compressor of claim 1 wherein:
said first cast iron is said gray cast iron; and
said second cast iron is said Meehanite-type cast iron.

19. The compressor of claim 18 wherein:
each said piston is essentially uncoated.
